(19) United States
(12) Patent Application Publication
(10) Pub. No.: US 2007/0280235 A1
(43) Pub. Date: Dec. 6, 2007

(54) SYSTEM AND METHOD FOR ACQUISITION AND DELIVERY OF SERVICES TO DEVICES IN A WIRELESS MULTICAST COMMUNICATION SYSTEM

(75) Inventors: An Mei Chen, San Diego, CA (US); Ravinder Paul (Rob) Chandhok, Poway, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 11/674,663

(22) Filed: Feb. 13, 2007

Related U.S. Application Data
(60) Provisional application No. 60/810,568, filed on Jun. 1, 2006.

(51) Int. Cl. H04H 1/00

(52) U.S. Cl. 370/390; 370/312

(57) ABSTRACT

A system and method are provided for acquiring and delivering services to a user device. A user device determines a network address associated with one or more servers providing unicast services. The device is activated and receives an interface for receiving multicast services from a content server. The user device then subscribes to one or more multicast services and receives content.

### CLAIM OF PRIORITY UNDER 35 U.S.C. §119

The present application for patent claims priority to Provisional Application No. 60/810,568, entitled “Methods for Acquiring and Delivery of Services to Devices in a Wireless Multicast Communication System” filed Jun. 1, 2006, and assigned to the assignee hereof and hereby expressly incorporated by reference herein.

### BACKGROUND

1. Field

The present disclosure relates generally to content delivery in a data network, and more specifically to methods and apparatus for acquiring and delivering services to a device in a wireless multicast network.

2. Background

The distribution of content to devices in a wireless network is a complicated process. This is particularly true for mobile devices, which may have limited resources, such as limited memory or limited battery power.

There is therefore a need in the art for a system and methods to enable a device to efficiently receive services in a wireless communication network.

### SUMMARY

According to one aspect, a method is provided for acquiring services on a user device in a multicast network. The method includes determining the network address associated with one or more servers providing unicast services, transmitting an activation request over a unicast connection between the user device and the network, acquiring an interface for receiving multicast services over a multicast connection, subscribing to one or more multicast services, and receiving content from the one or more multicast services subscribed to.

In another aspect, an apparatus for receiving content in a wireless communication network is provided. The apparatus comprises an activation module configured to discover one or more services implementing one or more unicast protocols, a subscription module configured to subscribe a user to one or more service packages, and a reception module configured to receive content from a content server.

### BRIEF DESCRIPTION OF THE DRAWINGS

FIG. 1 is a block diagram of a communications network for acquiring and delivering services;

FIG. 2 is a block diagram of a content server;

FIG. 3 is a block diagram of a server content management module;

FIG. 4 is a block diagram of a user device;

FIG. 5 is an operational flow diagram of a system for receiving and providing services;

FIG. 6 is an operational flow diagram of a service discovery process;

FIG. 7 is an operational flow diagram of a service activation process;

FIG. 8 depicts a physical layer superframe structure;

FIG. 9 is a flowchart depicting an interface acquisition process;

FIG. 10 is a conceptual block diagram depicting common overhead service;

FIG. 11 is a flowchart depicting a subscription process; and

FIG. 12 is another block diagram of a user device.

### DETAILED DESCRIPTION

The detailed description set forth below in connection with the appended drawings is intended as a description of various configurations of the invention and is not intended to represent the only configurations in which the invention may be practiced. The detailed description includes specific details for the purpose of providing a thorough understanding of the invention. However, it will be apparent to those skilled in the art that the invention may be practiced without these specific details. In some instances, well known structures and components are shown in block diagram form in order to avoid obscuring the concepts of the invention.

The concepts and techniques described herein may be used in various unicast and multicast systems that deliver content to subscribers over a wired and wireless medium. Examples of wired media include Ethernet systems, Digital Subscriber Lines (DSL), cable modem, fiber optics, standard telephone lines, and others. Examples of wireless media include cellular systems, broadcast systems, wireless local area network (WLAN) systems, and others. The cellular systems may be Code Division Multiple Access (CDMA) systems, Time Division Multiple Access (TDMA) systems, Frequency Division Multiple Access (FDMA) systems, Orthogonal Frequency Division Multiple Access (OFDMA) systems, Single-Carrier FDMA (SC-FDMA) systems, and other multiple access systems. The broadcast systems may be MediaFLO systems, Digital Video Broadcasting for Handhelds (DVB-H) systems, Integrated Services Digital Broadcasting for Terrestrial Television Broadcasting (ISDB-T) systems, and other broadcast systems. The WLAN systems may be IEEE 802.11 systems, Wi-Fi systems, and others. These systems are known in the art.

The concepts and techniques described herein are well suited for wireless systems with a single subcarrier as well as systems with multiple subcarriers. Multiple subcarriers may be obtained with OFDM, SC-FDMA, or some other modulation technique. OFDM and SC-FDMA partition a frequency band (e.g., the system bandwidth) into multiple orthogonal subcarriers, which are also called tones, bins, etc. Each subcarrier may be modulated with data. In general, modulation symbols are sent on the subcarriers in the frequency domain with OFDM and in the time domain with SC-FDMA. OFDM is used in various systems such as MediaFLO, DVB-H and ISDB-T broadcast systems, IEEE 802.11a/g WLAN systems, and some cellular systems. Certain aspects and configurations are described below for a unicast system that uses OFDM, e.g., a MediaFLO system.

A system and method are described herein for allowing a device to subscribe to and acquire multimedia services over a communication network. As described herein, the system and method enable the broadcast of audio and video signals, apart from non-real-time services to mobile users.

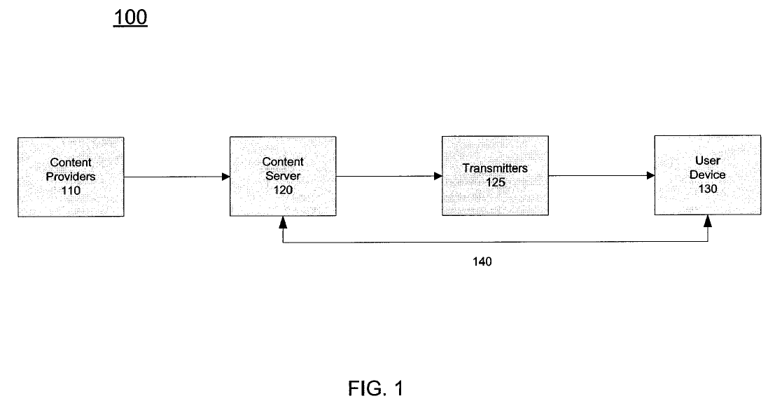

FIG. 1 is a simplified block diagram of a communications network 100 for acquiring and delivery services. Network 100 comprises one or more content providers 110, content server 120, and one or more user devices 130. In this example, the content may include media, such as video, audio, multimedia content, clips, scripts, programs, data and any other suitable content. The media may comprise real-time content, non-real-time content, and/or a combination of the two. Content server 120 receives content from content providers 110. Content server 120 may be configured to provide content to devices 120 via one or more transmitters 125. Additionally, content server 120 and devices 130 may exchange information over communication link 140. According to one configuration, transmitters 125 are tall, high power transmitters to ensure wide coverage in a geographical area.

Content providers 110 may be any external entity capable of transmitting media content over a network. User devices 130 may also be called an access terminal, handset, wireless subscriber, wireless unit, wireless device, wireless communications device, wireless telecommunications device, wireless telephone, cellular telephone, user terminal, user equipment, mobile station, mobile unit, subscriber station, wireless station, mobile radio, radio telephone, or some other terminology. User devices 130 may be any type of mobile device or terminal, such as, a mobile telephone, portable computer, personal digital assistant, or any other type of portable device capable of receiving data over a wireless communication link.

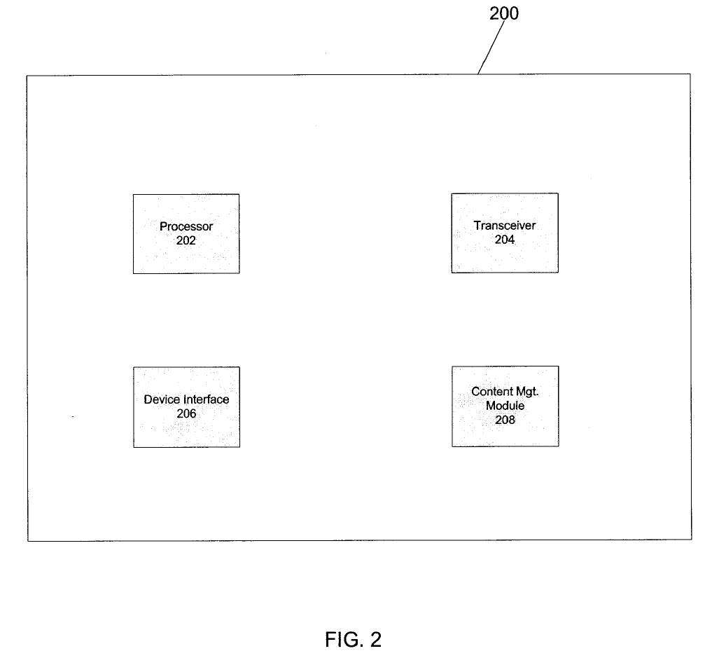

A content server, such as content server 120 depicted in FIG. 1, is illustrated in greater detail in FIG. 2. Content server 200 may include processor 202, transceiver 204, device interface 206, content management module 208, and/or other components. Processor 202 is configured to control one or more other functional elements of server 200. Accordingly, processor 202 may comprise a CPU, processor, gate array, hardware logic, memory elements, virtual machine, software, and/or any combination of hardware and software.

Device interface 206 comprises hardware and/or software that allow server 200 to communicate with internal and external systems. For example, internal systems may include mass storage systems, memory, display driver, mode, or other internal device resources. The external systems may include user interface devices, printers, disk drives, or other local devices or systems.

Transceiver 204 comprises hardware and/or software that operate to allow the server 200 to transmit and receive data and/or other information with remote devices, systems, or networks via communication channels. For example, transceiver 204 may facilitate forward link communication between server 200 and a user device via a transmitter such as transmitter 125 depicted in FIG. 1. In one configuration, transceiver 204 may facilitate forward and reverse link communication over a network such as network 140 as depicted in FIG. 1.

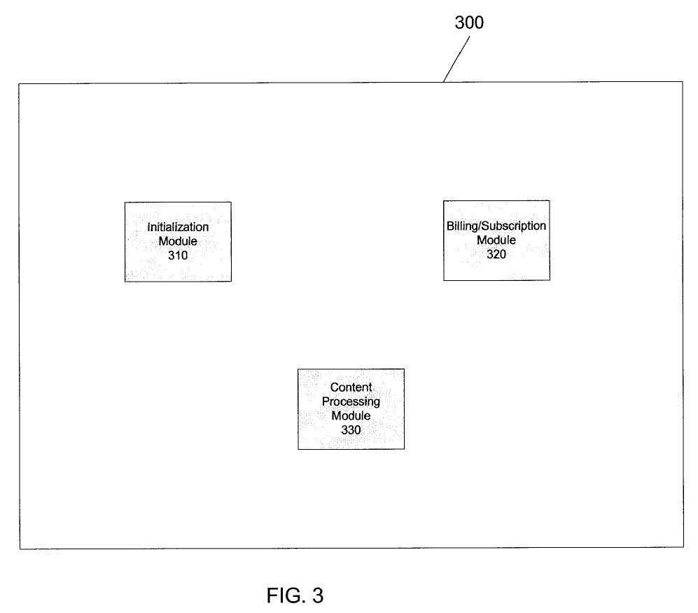

Content management module 208 may be configured to receive content from one or more content providers and to format the content for delivery to one or more user devices. Additionally, content management module 208 may be configured to manage user subscriptions and access to content. FIG. 3 depicts a content management module 300 comprising an initialization module 310, a billing and subscriptions module 320, and a content processing module 330.

Initialization module 310 may be configured to authorize and authenticate a user device in response to an authorization request. Additionally, initialization module 310 may be configured to provide overhead information to a user device indicating important system events, status information, and/or other information to assist the device in accessing network services. Initialization module 310 may also be configured to provide a listing of services available. For example, initialization module 310 may provide a program guide indicating service packages available to a user device.

Billing and subscriptions module 320 authenticates and authorizes a user device to access one or more service packages. For example, billing and subscriptions module may process authentication and encryption keys and provide licenses to the user device, enabling a user to access the selected one or more service packages.

Content processing module 330 may be configured to receive content from one or more content providers. Content may include, for example, real-time, non-real-time, and IP datacast data. Content processing module 330 may convert the content into a format that may be transmitted to user devices. Content processing module 330 may include logic to provide content at specified predetermined periods. In other configurations, content may be provided upon user request.

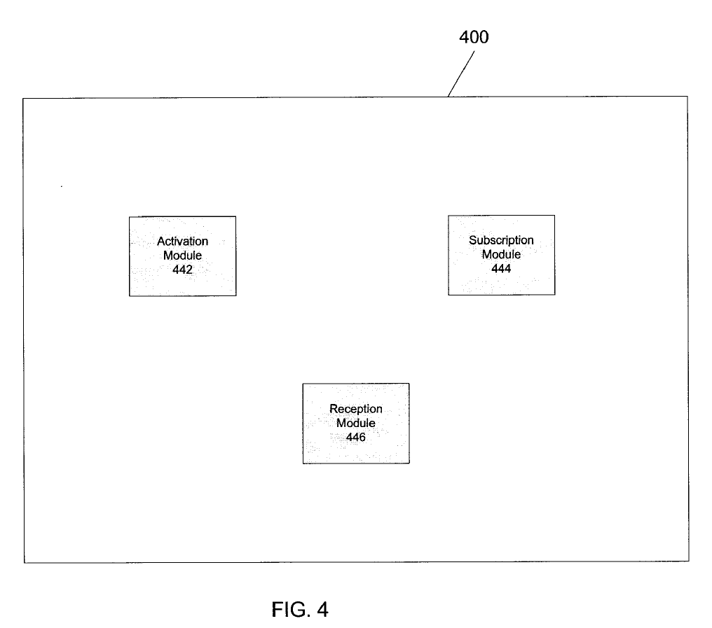

FIG. 4 depicts a user device 400 that may be used to receive content according to some configurations. User device 400 may comprise an activation module 442, subscription module 444, and reception module 446. When an application is launched on user device 400, activation module 442 may be configured to discover one or more servers implementing unicast protocols needed before content may be received. For example, activation module 442 may be configured to discover servers implementing subscription and billing services, license services, usage tracking services, configuration services, and/or other unicast services. Activation module 442 may also be configured to generate encryption keys needed to authenticate overhead information, acquire an interface for receiving content, and receive overhead information.

Subscription module 444 may be configured to enable a user of user device 400 to select and subscribe to one or more service packages. According to one configuration, user device 400 receives a program guide during activation that indicates available service packages. Subscription module 444 communicates with a content server to subscribe to the selected packages and to receive a license for those packages. Additionally, subscription module 444 may be configured to determine whether a package selected by the user can be supported by the user device 400.

Reception module 446 receives content from a content server. Content may be real-time, non-real-time, or IP datacast content. According to some configurations, reception module 446 receives content at predetermined time intervals. In other configurations, reception module 446 may be configured to receive content in response to a user initiated request.

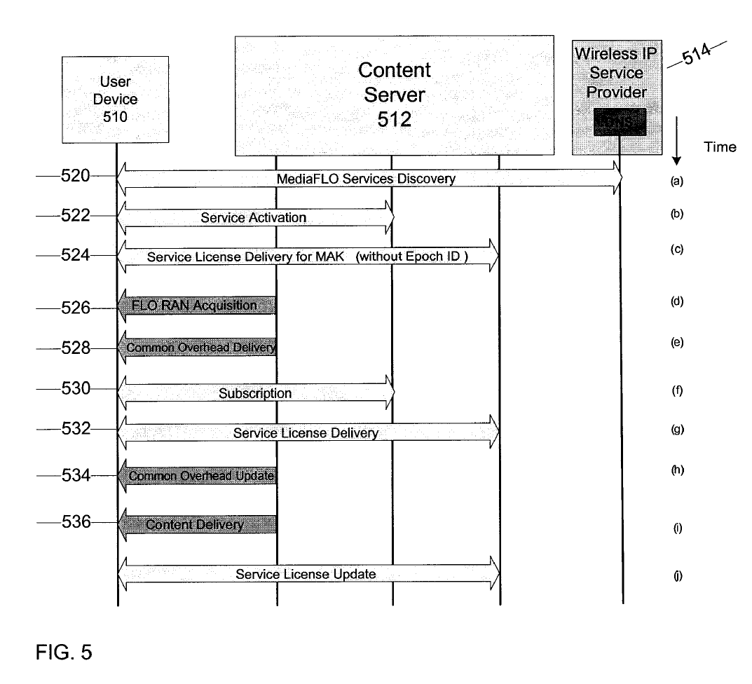

FIG. 5 depicts an overall operational flow of a system for receiving and providing services. As illustrated, a user device 510 communicates with a content server 512 and a wireless IP server 514. Before user device 510 can receive content, the device discovers unicast services, as depicted at 520. User device 510 may send a message to wireless IP server 514 to determine the IP addresses of unicast servers such as, for example, a subscription and billing server, a license key server, a usage tracking server, a unicast configuration server, and/or other servers providing unicast services.

User device 510 may then initiate an activation request by communicating with content server 512, as depicted at 522. Once activated, user device 510 may request an authentication key from content server 512, as depicted at 524. The activation key may be used to authenticate overhead information received from content server 512.

User device 510 may then receive an interface to receive content from content server 512, as depicted at 526. Additionally, the user device may receive overhead information, as depicted at 528. Overhead information may includes, for example, message notifications, system information, and/or other overhead information.

Once the user device has received the interface and overhead information, the user device may select and subscribe to one or more service packages, as depicted at 530. For each service package subscribed to, the user may then request a service license, as depicted at 532.

Periodically, user device 510 may receive and examine messages indicating updates to overhead information, as depicted at 534. As depicted at 536, the user device may receive content from the content server.

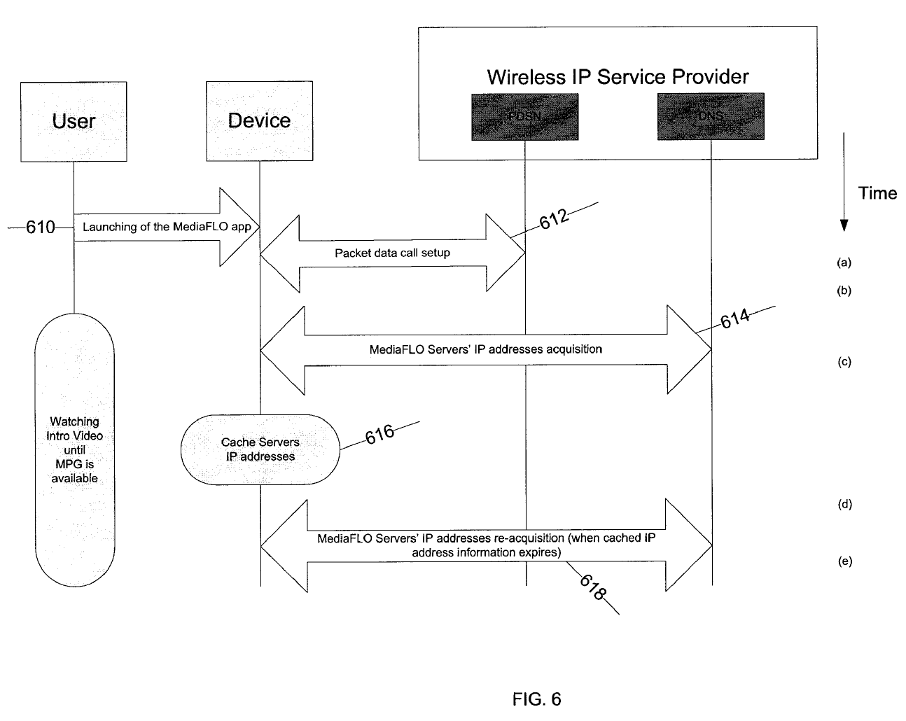

FIG. 6 depicts the service discovery process in greater detail. The service discovery process enables a user device to discover those servers implementing unicast protocols. As depicted at 610, the service discovery process may begin with a user launching an application on a user device for the first time. The user device may then establish a packet call data session with a wireless IP service provider, as depicted at 612. The user additionally obtains the address of the DNS server associated with the wireless IP service provider.

Once a call session has been established, the user device may acquire the IP addresses and port numbers associated with utility servers, as depicted at 614. For example, the device may acquire the addresses of a subscription and billing server, a license key server, a usage tracking server, a unicast configuration server, and/or other utility servers.

According to one configuration, the user device may cache IP address information obtained for future use, as depicted at 616. In addition to the address, each cache entry may include a field indicating the time and date on which the address was obtained and an expiration date. When the entry expires, the device may reacquire a server's IP address, as depicted at 618.

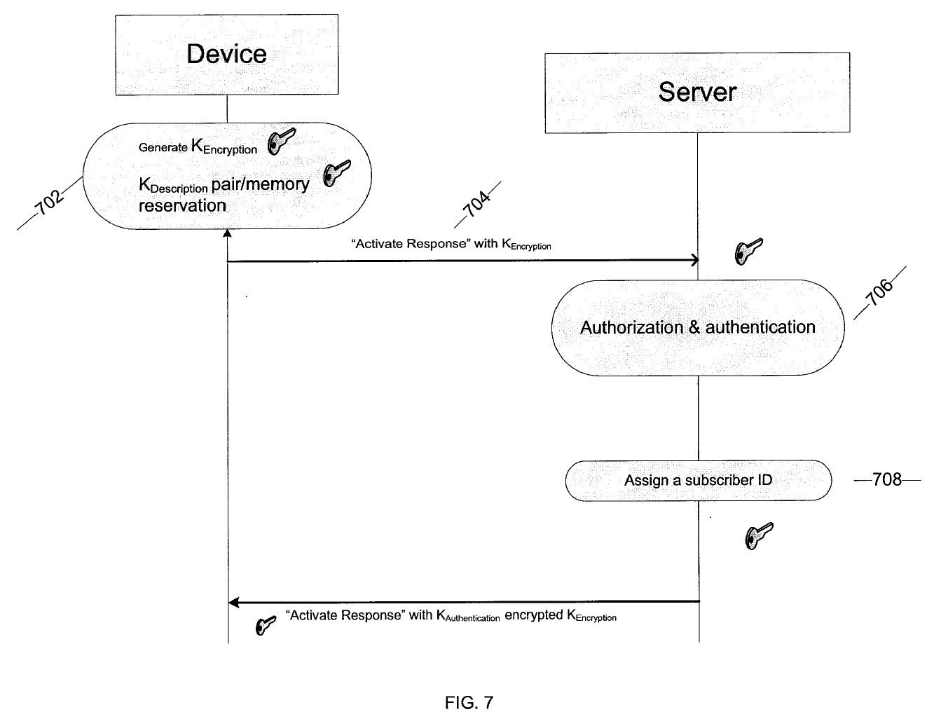

FIG. 7 depicts a service activation process, according to one configuration. A user device may begin the activation process by generating a public/private key pair, as depicted at 702. Additionally, the device may reserve space in memory for overhead information that will be delivered. The device may then transmit its encryption key to the server, as depicted at 704.

The server may then authorize and authenticate the activation request, as depicted at 706. Though the user device is not yet subscribed to any services, the server assigns a subscriber ID to the device, as depicted at 708. The subscriber ID may be used in subsequent communications between the server and the user device to facilitate subscriptions. The server responds with an authentication key, as depicted at 710.

Before a user device can access multicast services such as system overhead information and media content, the device must acquire an interface for receiving these services. The device may initiate an acquisition process to receive an interface, for example, when a user activates the play of real-time datacast services via the device's user interface, when content is scheduled to start transmission, or when the device is scheduled to receive overhead information.

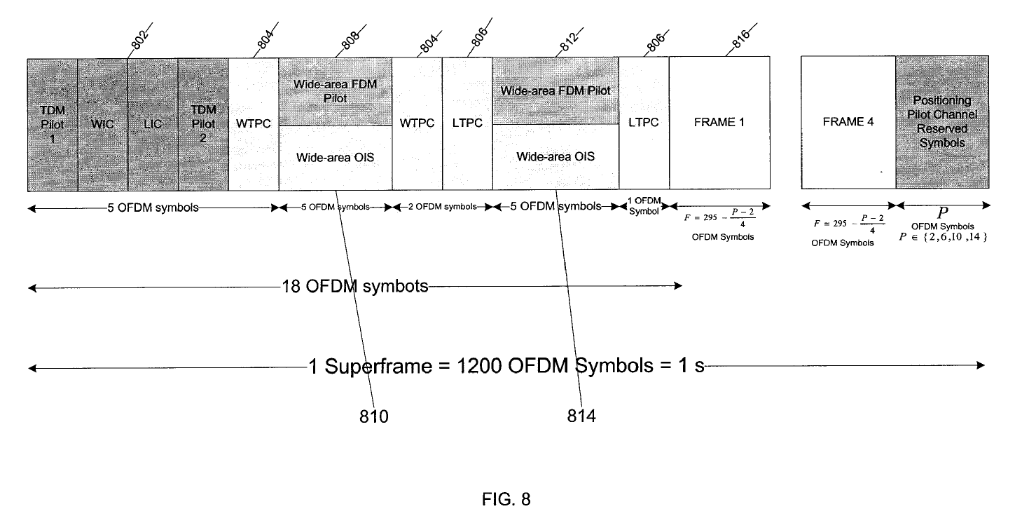

According to some configurations, the interface may be acquired through the transmission of physical layer superframes. In one configuration, orthogonal frequency division multiplexing (OFDM) technology is used. FIG. 8 depicts a physical layer superframe structure 800 comprising OFDM symbols. Generally, OFDM technology can achieve high spectral efficiency while effectively meeting mobility requirements. Additionally, OFDM can handle long delays from multiple transmitters with a suitable length of cyclic prefix; a guard interval added to the front of the symbol to facilitate orthogonality and mitigate inter-carrier interference.

As depicted in FIG. 8, an exemplary superframe 800 comprises 1200 OFDM symbols with a one second duration. While superframe 800 includes 1200 OFDM symbols, the number of OFDM symbols may vary. For example, the number of symbols may vary based on the channel bandwidth. The first four symbols of exemplary superframe 800 are time division multiplexed (TDM) pilot symbols 802, include TDM Pilot 1, wide area identification channel, local area identification channel, and TDM Pilot 2. Wide area transition pilot channels 804 and local area transition pilot channels 806 are provided to mark the beginning and end of the wide and local area channels, respectively. A wide area FDM pilot channel 808 is frequency division multiplexed with a wide area overhead information symbol channel 810. Similarly, a local area FDM pilot channel 812 is frequency division multiplexed with a wide area overhead information symbol channel 814. Frames 816 each contain wide area and local area data.

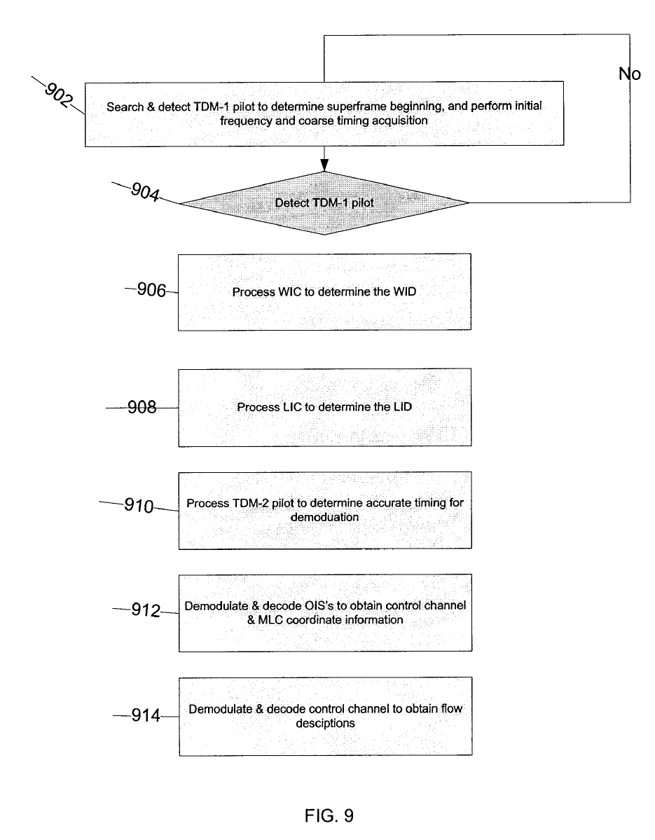

FIG. 9 is a flowchart depicting a process a device may use to acquire an interface for receiving content, according to one configuration. As depicted at 902, the device searches for the TDM-1 pilot symbol. This symbol is used to determine the superframe boundary. Additionally, it may be used to perform initial frequency and coarse timing acquisition. As depicted at 904, the search for the TDM-1 pilot symbol continues until it is detected.

Both the wide area identification channel (WIC) and the local-area identification channel (LIC) are processed, as depicted at 906, 908. The WIC is an overhead channel that is used for conveying the wide-area differentiator information to the user device. Similarly, the LIC is an overhead channel used to convey local-area differentiator information to the user device.

TDM-2 pilot symbol may be processed to determine accurate timing for demodulation, as depicted at 910. Once accurate timing has been determined, the device will demodulate and decode the wide-area and local area OIS to obtain information on control channels and a media logical channel, as depicted at 912. Using this information, the device may locate, demodulate, and decode the control channels to obtain control protocol messages, as depicted at 914. Control protocol messages may include flow description messages, RF channel description messages, neighbor list messages, and/or other control protocol messages. These messages indicate which media logical channel each waveform is mapped to.

After acquiring the network interface, the device can receive multicast services from a content server via one or more specific multicast addresses. These addresses indicate the available channels. For example, the channels may include CNN, ESPN, or other known channel. One or more multicast addresses may serve as the address for a multicast service. According to some configurations, each element of a multicast service may have associated with it a particular multicast address. For example, a service providing audio, video, text, and common overhead information may have a multicast address associated with each of those elements.

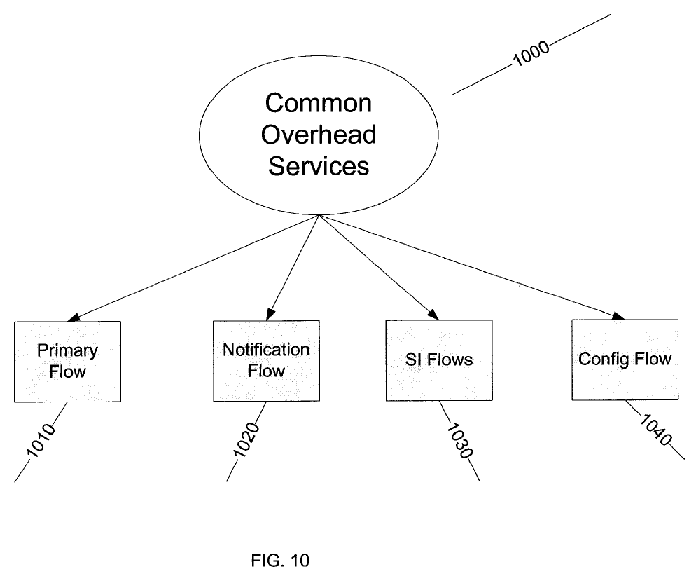

Overhead information may be carried by a common overhead service. Overhead information carries control information about the services. FIG. 10 depicts the high level concept of common overhead service. Common overhead service 1000 may include a primary flow 1010, a notification flow 1020, multiple system information flows 1030, and a configuration flow 1040. The common overhead services enable a user device to receive real-time, non-real-time, and IP datacast services. Common overhead services do not carry media content. However, these services enable a user device to receive media content.

Overhead information may be broadcast over the network to inform devices of important system events, state and status information, system information, and to assist the device in accessing other services. System information flows 1030 may include marketplace and service information as well as a media presentation guide. These flows assist the user in subscribing to services and viewing content.

Primary flow 1010 may be configured to indicate whether notification flows, system information flows, service keys, client applications, or other services have been updated. According to one configuration, a device first checks the primary message to determine which information has been updated, and then updates accordingly. When the device receives a primary message from the primary flow, the device may examine its version to determine whether it is a new message. If so, the device examines the message content to determine updates.

Notification flow 1020 may be configured to provide a plurality of notification messages to a user device. Notification messages may include, for example, usage tracking notifications, service alerts, client application upgrade notifications, and/or other notifications.

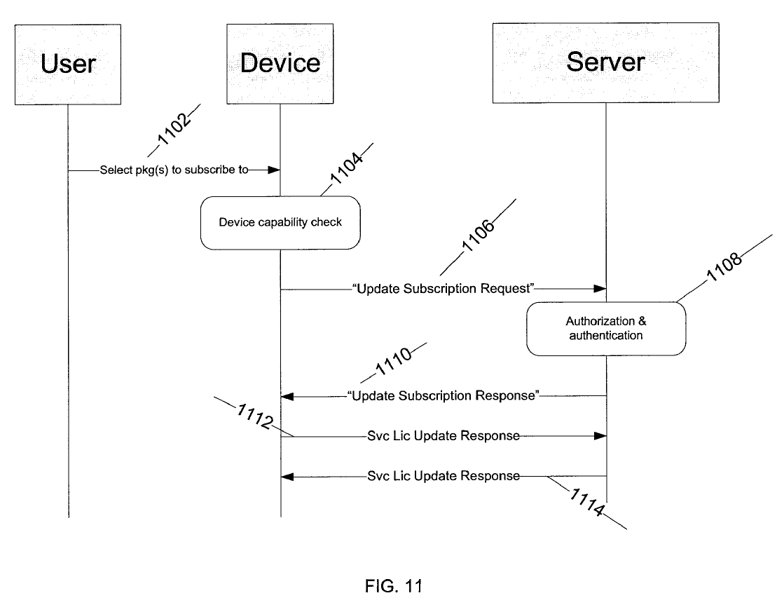

After receiving marketplace information, a user may select one or more packages to subscribe to. FIG. 11 depicts a subscription process, according to one configuration. As depicted at 1102, a user may select one or more packages to subscribe to. The marketplace information provides a list of available packages. The device then performs a capability check to see if it is able to handle the selected packages, as depicted at 1104. For example, the device may check the amount of memory required to run the package, language compatibility, and/or other capability checks. If the device is unable to handle the package, the device may present a notification to the user indicating its inability to handle the package.

As depicted at 1106, if the device is able to handle the package, the device transmits a subscription update request to the server. The server then authorizes and authenticates the request, as depicted at 1108, and transmits a subscription response indicating whether the subscription is successful, as depicted at 1110.

Upon successful subscription, the device may transmit a service license update to the server, as depicted at 1112, requesting a license to use the package. After authorizing and authenticating the request, the server responds with a service license for the new services, as depicted at 1114.

As described above, a content server may provide real-time, non-real-time, and IP datacast data. According to one configuration, non-real-time data may be delivered in bulk at prescheduled times. The non-real-time service multicast may be configured to present the file to devices with a subscription to the service before the availability time advertised to the user in the presentation guide. According to one configuration, the device receives content for such subscribed service as a background process. That is, no user intervention is needed. Delivery of non-real-time data may minimize device on-time and thereby increase battery life. According to one configuration, a schedule is advertised to subscribed devices indicating when the file is available for download. The receiver can then turn-on at the time the file is being transmitted.

For real-time services, the content server may present a service as one or more continuous flows. Each flow may be identified by a unique identification. The device may be configured to determine which flows carry a particular service based on broadcast system information.

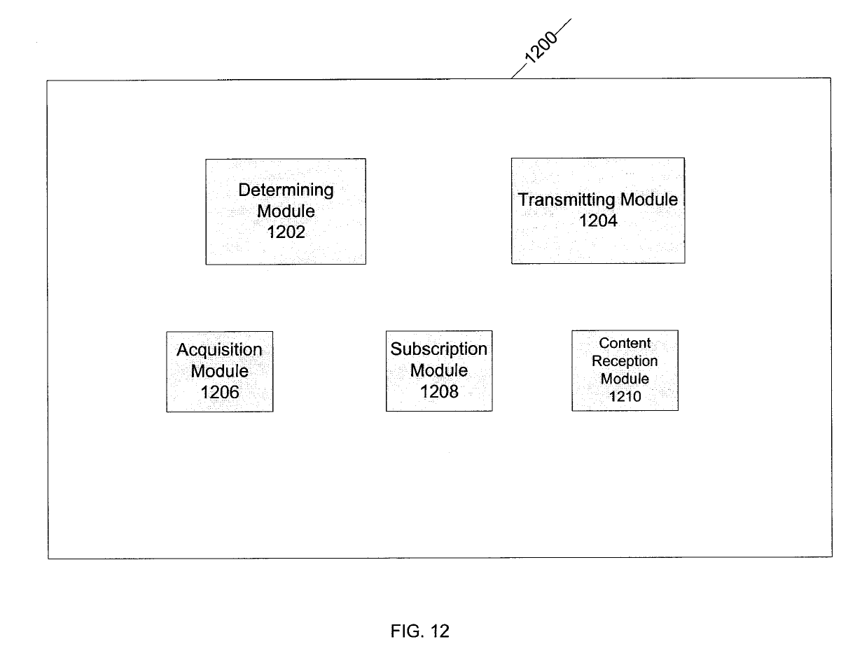

FIG. 12 is a block diagram depicting a user device 1200 suitable for use in one or more configurations. User device 1200 comprises a module 1202 for determining a network address associated with one or more servers providing unicast services, a module 1204 for transmitting an activation request over a unicast connection between the user device and the network, a module 1206 for acquiring an interface for receiving multicast services over a multicast connection, a module 1208 for subscribing to one or multicast services, and a module 1210 for receiving content from the one or more multicast services subscribed to.

The previous description of the disclosed configurations is provided to enable any person skilled in the art to make or use the present invention. Various modifications to these configurations will be readily apparent to those skilled in the art, and the generic principles defined herein may be applied to other configurations without departing from the spirit or scope of the invention. For example, those skilled in the art will recognize the interchangeability of hardware, firmware, and software configurations for certain disclosed modules, and how best to implement the described functionality for each particular application. Thus, the present invention is not intended to be limited to the configurations shown herein, but is to be accorded the full scope consistent with the claims, wherein reference to an element in the singular is not intended to mean “one and only one” unless specifically so state, but rather “one or more.” All structural and functional equivalents to the elements of the various configurations described throughout this disclosure that or known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

What is claimed is:

1. A method for acquiring services on a user device in a multicast communication network comprising:
determining the network address associated with one or more servers providing unicast services;
transmitting an activation request over a unicast connection between the user device and the network;
acquiring an interface for receiving multicast services over a multicast connection;
subscribing to one or multicast services; and
receiving content from the one or more multicast services subscribed to.

2. The method of claim 1, wherein determining the network address associated with the one or more servers providing unicast services further comprises:
performing a service discovery procedure to find the IP address and port number associated with the one or more servers providing unicast services; and
storing the IP address in a cache memory for a predetermined time.

3. The method of claim 1, wherein the one or more servers proving unicast services are configured to perform at least one of the following: activate a user device, provide subscriptions, provide license keys, and upload usage tracking data.

4. The method of claim 1, wherein transmitting an activation request further comprises:
generating a public/private encryption key pair;
receiving an authorization and authentication message from a subscription and billing server; and
receiving an authentication key from a licensing key server.

5. The method of claim 1, wherein acquiring an interface for multicast services further comprises:
receiving a physical layer superframe;
decoding pilot symbols to determine the superframe boundary;
processing a wide area identification channel;
processing a local area identification channel;
decoding overhead information to determine a control channel and a media logical channel;
and decoding the control channel to obtain control protocol messages.

6. The method of claim 5, wherein the control protocol messages indicate which media logical channel each superframe is mapped to.

7. The method of claim 1, wherein the overhead information comprises one or more of system information, configuration information, and notification information.

8. The method of claim 1, wherein the overhead information comprises a primary messages indicating whether any information has been updated.

9. The method of claim 1, wherein subscribing to one or more multicast services comprises:
selecting one or more services to subscribe to;
determining whether the user device is configured to support the selected one or more services; and
if the device is configured to support the selected service, receiving a license for the selected service.

10. The method of claim 1, wherein receiving content comprises receiving one or more of non-real-time content, real-time content, and IP datacast data.

11. The method of claim 10, wherein the content is non-real-time content, and receiving content comprises receiving content in bulk at a prescheduled time.

12. The method of claim 10, wherein the content is real-time content, and receiving content comprises selecting content from a programming guide.

13. An apparatus for receiving content in a wireless communication network comprising:
an activation module configured to discover one or more services implementing one or more unicast protocols;
a subscription module configured to subscribe a user to one or more service packages; and
a reception module configured to receive content from a content server.

14. The apparatus of claim 13, wherein the activation module is further configured to:
generate encryption keys to authenticate the apparatus;
acquire an interface for receiving the one or more service packages; and
receive overhead information.

15. The apparatus of claim 13, wherein the subscription module is further configured to:
receive a program guide describing the one or more service packages; and
transmit a request to the content server to obtain a license for the selected service packages.

16. The apparatus of claim 13, wherein the subscription module is further configured to:
determine whether the apparatus is able to support one or more selected service packages based, at least in part, on the amount of memory required to run the selected one or more service packages.

17. That apparatus of claim 13, wherein the reception module receives content at predetermined time intervals.

18. The apparatus of claim 13, wherein the reception module receives content in response to a user-initiated request.

19. An apparatus for providing content to a user device, comprising:
an initialization module configured to provide overhead information to the user device;
a billing and subscriptions module configured to authorize the user device to access one or more service packages; and
a content processing module configured to receive content from one or more content providers and format the content for transmission to the user device.

20. The apparatus of claim 19, wherein the initialization module is further configured to provide an authentication key used to authenticate the overhead information.

21. The apparatus of claim 19, wherein the initialization module is further configured to provide a listing of service packages available to the user device.

22. The apparatus of claim 19, wherein the billing and subscriptions module is further configured to provide a license to the user device to use a selected service package.

23. The apparatus of claim 19, wherein the content processing module is configured to provide content to the user device at predetermined time intervals.

24. The apparatus of claim 19, wherein the content processing module is configured to provide content to the user device in response to a user-initiated request.

25. A user device for receiving services in a multicast communication network comprising:
means for determining a network address associated with one or more servers providing unicast services;
means for transmitting an activation request over a unicast connection between the user device and the network;
means for acquiring an interface for receiving multicast services over a multicast connection;
means for subscribing to one or multicast services; and
means for receiving content from the one or more multicast services subscribed to.

26. The user device of claim 25, wherein the means for determining the network address associated with the one or more servers providing unicast services further comprises:
means for performing a service discovery procedure to find the IP address and port number associated with the one or more servers providing unicast services; and
storing the IP address in a cache memory for a predetermined time.

27. The user device of claim 25, wherein the one or more servers providing unicast services include at least one of a subscription and billing server, a license key server, a usage tracking server, and a unicast configuration server.

28. The user device of claim 25, wherein the means for transmitting an activation request further comprises:
means for generating a public/private encryption key pair;
means for receiving an authorization and authentication message from a subscription and billing server; and
means for receiving an authentication key from a licensing key server.

29. The user device of claim 25, wherein the means for acquiring an interface for multicast services further comprises:
means for receiving a physical layer superframe;
means for decoding pilot symbols to determine the superframe boundary;
means for processing a wide area identification channel;
means for processing a local area identification channel;
means for decoding overhead information to determine a control channel and a media logical channel;
and means for decoding the control channel to obtain control protocol messages.

30. The user device of claim 29, wherein the control protocol messages indicate which media logical channel each superframe is mapped to.

31. The user device of claim 25, wherein the overhead information comprises one or more of system information, configuration information, and notification information.

32. The user device of claim 25, wherein the overhead information comprises a primary messages indicating whether any information has been updated.

33. The user device of claim 25, wherein the means for subscribing to one or more multicast services comprises:
means for selecting one or more services to subscribe to;
means for determining whether the user device is configured to support the selected one or more services; and
if the device is configured to support the selected service, means for receiving a license for the selected service.

34. The user device of claim 25, wherein the means for receiving content comprises receiving one or more of non-real-time content, real-time content, and IP datacast data.

35. The user device of claim 34, wherein the content is non-real-time content, and receiving content comprises receiving content in bulk at a prescheduled time.

36. The user device of claim 34, wherein the content is real-time content, and receiving content comprises selecting content from a programming guide.

37. A computer readable medium embodying a program of instructions executable by a computer to perform a method for acquiring services on a user device in a multicast communication network, the method comprising:
determining the network address associated with one or more servers providing unicast services;
transmitting an activation request over a unicast connection between the user device and the network;
acquiring an interface for receiving multicast services over a multicast connection;
subscribing to one or multicast services; and
receiving content from the one or more multicast services subscribed to.

38. The computer readable medium of claim 37, wherein determining the network address associated with the one or more servers providing unicast services further comprises:
performing a service discovery procedure to find the IP address and port number associated with the one or more servers providing unicast services; and
storing the IP address in a cache memory for a predetermined time.

39. The computer readable medium of claim 37, wherein the one or more servers proving unicast services are configured to perform at least one of the following:
activate a user device, provide subscriptions, provide license keys, and upload usage tracking data.

40. The computer readable medium of claim 37, wherein transmitting an activation request further comprises:
generating a public/private encryption key pair;
receiving an authorization and authentication message from a subscription and billing server; and
receiving an authentication key from a licensing key server.

41. The computer readable medium of claim 37, wherein acquiring an interface for multicast services further comprises:
receiving a physical layer superframe;
decoding pilot symbols to determine the superframe boundary;
processing a wide area identification channel;
processing a local area identification channel;
decoding overhead information to determine a control channel and a media logical channel;
and decoding the control channel to obtain control protocol messages.

42. The computer readable medium of claim 41, wherein the control protocol messages indicate which media logical channel each superframe is mapped to.

43. The computer readable medium of claim 37, wherein the overhead information comprises one or more of system information, configuration information, and notification information.

44. The computer readable medium of claim 37, wherein the overhead information comprises a primary messages indicating whether any information has been updated.

45. The computer readable medium of claim 37, wherein subscribing to one or more multicast services comprises:
selecting one or more services to subscribe to;
determining whether the user device is configured to support the selected one or more services; and
if the device is configured to support the selected service, receiving a license for the selected service.

46. The computer readable medium of claim 37, wherein receiving content comprises receiving one or more of non-real-time content, real-time content, and IP datacast data.

47. The computer readable medium of claim 46, wherein the content is non-real-time content, and receiving content comprises receiving content in bulk at a prescheduled time.

48. The computer readable medium of claim 46, wherein the content is real-time content, and receiving content comprises selecting content from a programming guide.
